(19) United States
(12) Patent Application Publication
(10) Pub. No.: US 2016/0001807 A1
(43) Pub. Date: Jan. 7, 2016

(54) Motor Vehicle Steering Wheel

(71) Applicants: TAKATA AG, Aschaffenburg (DE); AUDIO MOBIL ELEKTRONIK GMBH, Braunau am Inn - Ranshofen (AT)

(72) Inventors: Andreas HANS, Aschaffenburg (DE); Norbert MÜLLER, Aschaffenburg (DE); Heiko RUCK, Aschaffenburg (DE); Thomas STOTTAN, Ranshofen (AT); Martin GRADINGER, Mühlheim am Inn (AT)

(73) Assignees: TAKATA AG, Aschaffenburg (DE); AUDIO MOBIL ELEKTRONIK GMBH, Braunau am Inn - Ranshofen (AT)

(21) Appl. No.: 14/770,319

(22) PCT Filed: Feb. 14, 2014
(86) PCT No.: PCT/EP2014/052927

§ 371 Date: Aug. 25, 2015

(30) Foreign Application Priority Data
Feb. 28, 2013 (DE) 10 2013 102 014.3

(51) Int. Cl. B62D 1/04; G06F 3/0488; B60R 11/02; B60R 21/2165; B60R 21/203; B60K 35/00

(52) U.S. Cl. CPC B62D 1/046; B60R 21/203; B60K 35/00; B60R 11/0229; B60R 21/21656; G06F 3/0488; B60R 2011/001

(57) ABSTRACT

A motor vehicle steering wheel with at least one gripping portion for gripping the steering wheel by a driver and with a central steering wheel region which is connected with the gripping portion is provided. The central steering wheel region—based on the state of the steering wheel properly mounted in a motor vehicle—forms a cover surface facing the driver, wherein behind the cover surface a receptacle for a gas bag is arranged and the cover surface defines an outlet opening through which the gas bag can be deployed for the protection of the driver. The steering wheel furthermore comprises an electronic display device with a screen. The screen is provided beside the outlet opening on the cover surface of the central steering wheel region, and the surface of the screen amounts to at least 60% of the opening cross-section of the outlet opening.

This invention relates to a motor vehicle steering wheel according to the generic part of claim 1.

Such steering wheel comprises at least one gripping portion for gripping the steering wheel by a driver, for example in the form of a steering wheel rim, as well as a central steering wheel region, which—e.g. via spokes—is connected with the gripping portion of the steering wheel and which—based on the state of the steering wheel properly mounted in a motor vehicle—forms a cover surface associated to the driver. Behind that cover surface, a receptacle fore gas bag is arranged, and the cover surface defines an outlet opening through which the gas bag can be deployed for the protection of the driver, when it is inflated by means of a gas generator in the case of a crash. By forming an airbag module, the gas generator together with the gas bag can be arranged in the receptacle provided behind the cover surface of the central steering wheel region. In principle, however, an arrangement of the gas generator separate from the gas bag also is possible, in case a fluid connection exists, via which the gases released by the gas generator in the case of a crash are introduced into the gas bag.

The outlet opening, through which the gas bag can be deployed on inflation, in order to protect the driver of a motor vehicle against injuries in the case of a crash, usually is closed before activation of the gas generator and the related inflation of the gas bag, e.g. by a flap which can be folded away from the deploying gas bag, in order to clear the outlet opening.

It is known that such steering wheel furthermore can include an electronic display device with a screen, in order to display information required or desired by the driver. Such display device integrated into the steering wheel is provided in addition to the display means provided on the instrument panel or the center console of a motor vehicle and provides for specifically directing the attention of the driver to particular displays. In the present case, a screen usually is understood in particular to be an electrically or electronically actuated (uniform) display area, on which temporally variable information in the form of images or signs is displayed optically (without any components to be moved mechanically for display purposes, such as e.g. a speedometer needle).

It is the problem underlying the invention to further improve a motor vehicle steering wheel as mentioned above.

According to the invention, this problem is solved by creating a motor vehicle steering wheel with the features of claim 1.

Accordingly, in a generic motor vehicle steering wheel the screen of the display device is provided on the cover surface of the central steering wheel region beside the outlet opening, wherein the surface covered by the screen on the cover surface of the central steering wheel region amounts to at least 60% of the opening cross-section of the outlet opening.

The solution according to the invention is based on the finding that the joint arrangement both of a large-surface outlet opening of an airbag module and of a large-surface screen of a display device in the central steering wheel region is possible when the same are arranged one beside the other on the cover surface of the central steering wheel region facing the driver. This means that the outlet opening and the screen are arranged one beside the other without overlap on the cover surface of the central steering wheel region. As a result, the deployment of the gas bag through the outlet opening is not impeded in the case of a crash, as the screen is not located in the path of deployment of the gas bag.

In case the outlet opening is closed by means of a cover in the usual way, which covers the gas bag properly arranged in its receptacle, the screen is arranged on the cover surface of the central steering wheel region separately and spatially separate (at a distance) from that cover, i.e. In particular not connected with the cover (and hence not movable either along with the same, when the outlet opening, e.g. by folding the cover away, is to be cleared for a deployment of the gas bag). During a deployment of the gas bag, the screen hence can stationarily remain at its intended place in the central steering wheel region, without its spatial position being influenced substantially by the deployment of the gas bag (apart from a possible limited deformation of the central steering wheel region outside the outlet opening).

In particular, the outlet opening and the screen substantially can extend in a plane which is vertical to the steering axis, wherein however due to a regularly (e.g. for design reasons) slightly curved design of the cover surface of the central steering wheel region certain deviations from an ideal two-dimensional plane are obtained.

Furthermore, the solution according to the invention has the advantage theta display device integrated into the steering wheel with a large-surface display can take over many or even ail functions which previously have been performed by display devices on the instrument panel and/or the center console and possibly by display means faded in on the windshield. At the same time, this opens up new degrees of freedom for the design of the instrument panel and the center console of a motor vehicle.

According to a development of the invention, the surface of the screen integrated into the central steering wheel region, which serves as display, amounts to at least 70%, in particular at least 85% of the cross-section of the outlet opening for a gas bag, which likewise is integrated into the central steering wheel region. It can also be provided that the surface of the screen is at least as large as said opening cross-section, i.e. In particular also larger than the latter.

Furthermore, the spatial position and/or orientation of the screen on the central steering wheel region can be adjustable variably, in particular by pivotally mounting the screen on the central steering wheel region. A driver thereby can selectively make adjustments with a view to his personal needs. The screen also can removably be arranged on the central steering wheel region.

A pivotable or removable arrangement of the screen on the central steering wheel region can include the possibility that in addition to the screen itself still further elements, in particular further components of the display device, possibly are removable or pivotable together with the screen.

The surface of the screen can be divided, e.g. by corresponding programming of a control device associated to the screen, into at least two regions of which the one (e.g. upper) region serves for displaying particularly (safety-)relevant information, such as the vehicle speed, which is displayed continuously, while another (e.g. lower) screen region includes temporally changing displays, for example concerning the vehicle navigation, mobile telephony, the state of various vehicle components etc. This means that by the at least two regions into which the screen is divided information to be provided permanently is displayed in one region in operation of a motor vehicle and in the other region information required only at times is displayed during operation of a motor vehicle. The latter in particular can be effected in a temporal change (possibly depending on demand), i.e. for instance at times mobile telephony, at times vehicle navigation, etc.

Furthermore, it is possible to represent information faded in on the screen such that independent of the angle of rotation of the steering wheel it always is oriented along one and the same direction, so that for example a speed indication on the screen always is oriented to the driver in the same way and hence is easily readable independent of the steering angle.

In addition to the screen, further display elements can be integrated into the motor vehicle steering wheel, in particular into its central steering wheel region, such as e.g. Indicator lamps. To relieve the instrument panel and possibly the center console of such display elements, the major part or even the entirety of such display elements can be integrated into the steering wheel.

The same applies for control elements, e.g. In the form of switches or pushbuttons, which likewise can be integrated into the steering wheel, in particular into the central steering wheel region, and in particular such that they—or at least a part of the control elements—can be reached from the gripping region of the steering wheel (in the form of a steering wheel rim).

In addition, at least a part of the control elements, in particular control elements mounted beside the screen, can be assigned with different functions depending on the information displayed on the screen. This can be effected e.g. by an electronic control device which also controls the display on the screen.

The screen itself also can be designed touch-sensitive, so that control elements also can be integrated into the screen. For example, commands to components of the motor vehicle can be generated by acting on the screen.

Further details and advantages of the invention will become apparent from the following description of exemplary embodiments with reference to the Figures.

In the drawing:

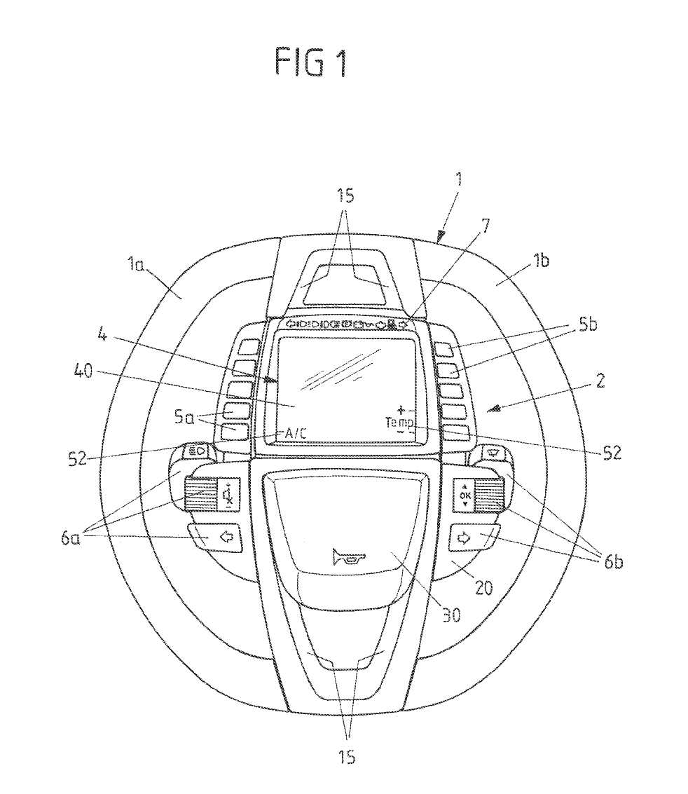

FIG. 1 shows a perspective top view of a motor vehicle steering wheel with a large-surface screen in the central steering wheel region;

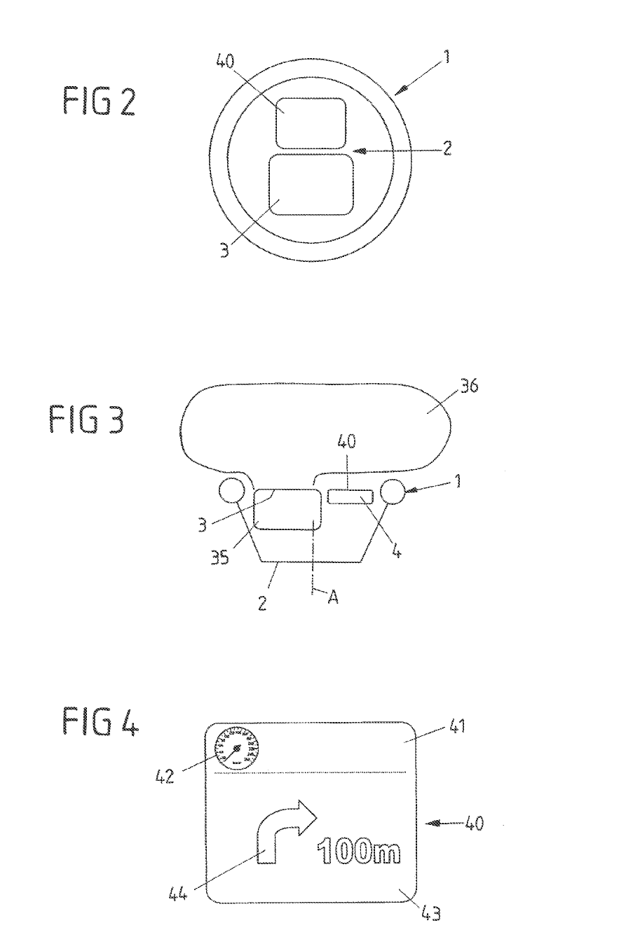

FIG. 2 shows a schematic top view of a steering wheel according to FIG. 1;

FIG. 3 shows a schematic cross-sectional representation of a steering wheel according to FIG. 1 with deployed airbag;

FIG. 4 shows a schematic representation of the screen of FIG. 1;

FIGS. 5A and 5B show a schematic representation of the screen of FIG. 1 at two different steering angles;

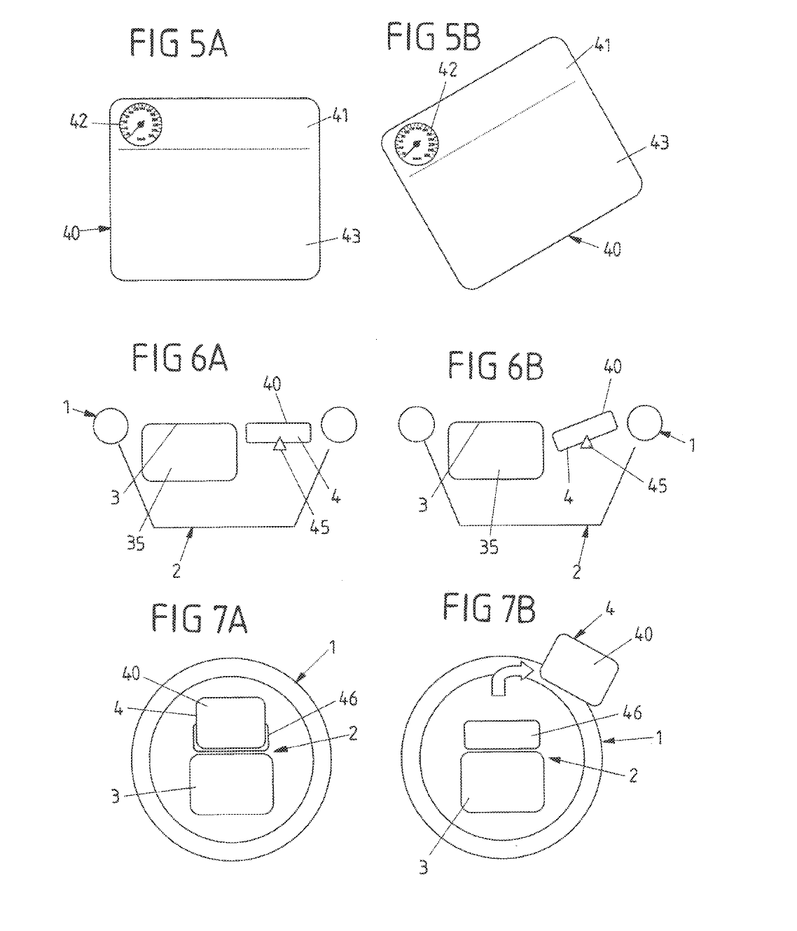

FIGS. 6A and 6B show a schematic cross-sectional representation of the steering wheel of FIG. 1 at two different angular positions of the screen;

FIGS. 7A and 7B show a schematic top view of a steering wheel according to FIG. 1 with removable screen.

FIGS. 1 and 2 show a perspective top view (FIG. 1) and a schematically simplified top view (FIG. 2) of a motor vehicle steering wheel, which in the usual way includes a steering wheel rim 1 which here is formed by two gripping regions 1a, 1b, by way of example. In the exemplary embodiment—based on the normal position of the steering wheel corresponding to a straight-ahead travel—these are a left-side gripping region 1a and a right-side gripping region 1b.

Via spokes 15, the gripping regions 1a, 1b of the steering wheel are connected with a central steering wheel region 2 which—based on the state of the steering wheel properly mounted in a motor vehicle—includes a cover surface 20 facing the driver. The cover surface 20 extends substantially vertical to the steering axis A (see FIG. 3) of the steering wheel, but is slightly curved, e.g., for design reasons.

Behind the cover surface 20, there is arranged a receptacle 35 (see FIG. 3) for an airbag module, in particular for a gas bag of an airbag module. A gas bag stowed in the receptacle 35 behind the cover surface 20 of the central steering wheel region 2 in the usual way serves to protect the driver in the case of a crash. For this purpose, the gas bag is inflatable by means of an associated gas generator, which likewise can be accommodated in that receptacle 35, so that it is deployed in direction of the vehicle occupant to be protected and forms a gas cushion for retaining the driver in the case of a crash.

To provide for such deployment of the gas bag 36, as shown in FIG. 3, the cover surface 20 of the central steering wheel region 2 defines an outlet opening 3, see FIG. 2, through which the gas bag 36 can be deployed in the case of a crash. This opening 3, however, initially is closed by a cover 30 integrated into the cover surface 20 or forming a part of the cover surface 20, as can be seen in FIG. 1.

The cover 30 is designed such that it clears the outlet opening 3 upon inflation and deployment of the gas bag. It therefore is known to design the cover 30 such that it can be torn off, folded away and/or destroyed (by action of the deploying gas bag). The concrete mechanism which clears the outlet opening 3 upon inflation and deployment of the gas bag is not important here.

With reference to FIGS. 1 and 2 it furthermore becomes clear that in the central steering wheel region 2, more exactly on its cover surface 20, a display device 4 with a large-surface screen 40 furthermore is provided. The same is arranged on the cover surface 20 beside the outlet opening 3 or the associated cover 30; namely in the exemplary embodiment such that the outlet opening 3 and the screen 40 substantially lie in a plane which extends vertically to the steering axis A of the steering wheel, as becomes clear in particular with reference to a synopsis of FIGS. 1, 2 and 3. However, there are certain (limited) deviations from an arrangement of the two elements 3, 40 in exactly one plane, as the cover surface 20 of the central steering wheel region 2 regularly has a certain curvature, e.g. for design reasons. It is important here that the outlet opening 3 and the screen 40 lie one beside the other without overlap on the cover surface 20. Each point of the cover surface 20, which forms a part of the screen 40, is spaced from the outlet opening 3 along the cover surface 20. In the exemplary embodiment the screen 40 furthermore is arranged in the 12 o'clock position—based on the position of the steering wheel corresponding to a straight-ahead travel and relative to the outlet opening 3.

What is particularly important here is the large-surface design of the screen 40 (display) of the display device 4, whose surface area according to the invention should amount to at least 60%, in particular at least 70% or even at least 80% or 85%, of the surface area of the opening cross-section (concealed by the cover 30, rectangular in the exemplary embodiment according to FIG. 2) of the outlet opening 3 for a gas bag, In one aspect it can even be provided that the surface of the screen 40 serving as uniform display is greater than the opening cross-section of the outlet opening 3.

Such large-surface design of the screen 40 does not impede the deployment of a gas bag 36 as shown in FIG. 3 from the receptacle 35 arranged behind the cover surface 20 of the central steering wheel region 2, as—because of the arrangement of the screen 40 on the cover surface 20 beside the outlet opening 3—the gas bag 36 easily can expand above the screen 40.

According to FIG. 4, the screen 40 can be divided into two or more main regions 41, 43, to which different functions are assigned. A first, in the exemplary embodiment upper, region 41 thus can serve for displaying information 42 such as e.g. the speed of the motor vehicle, which in operation of the motor vehicle must be displayed continuously as safety-relevant information. A second, in the exemplary embodiment lower region 43 of the screen 40 on the other hand can serve for displaying information which the driver must take note of only at certain times, so that in this region 43 of the screen 40 different items of information 44 are displayed time-dependently, such as e,g. Indications of a navigation device, a dial for mobile telephony, indications concerning the state of various components of the motor vehicle, etc.

The screen 40 can be actuated by means of an associated control device such that the information displayed on the screen 40 or at least a part thereof, as shown in FIGS. 5A and 5B, always are oriented in the same way independent of the current steering angle. In the exemplary embodiment this in particular relates to the (safety-relevant) information 42 displayed in the first (upper) screen region 41, such as e.g. the vehicle speed. Since the indication of such information always is oriented in the some way within the vehicle independent of the steering angle, this information always can be detected by the driver easily and reliably independent of the steering angle, which is of particular importance in the case of safety-relevant information.

As shown in FIGS. 6A and 6B, the screen 40 or possibly the display device 4 comprising the screen 40 altogether can be arranged on the central steering wheel region 2 such that the spatial position of the screen 40 or the display device 4 can be adjusted variably, e.g. by shifting and/or pivoting. In the exemplary embodiment of FIGS. 6A and 6B the display device 4 is pivotally connected with the screen 40 by means of a swivel device 45 (e.g. about a swivel axis). The spatial orientation of the screen 40 thereby can be adapted to the individual needs of a respective driver by pivoting,

According to a development shown in FIGS. 7A and 7B, the screen 40 is removably arranged on a holder 46 of the central steering wheel region 2, so that the screen 40 or the associated display device 4 altogether can be removed when necessary, for example when leaving the vehicle in a theft-prone environment.

The removable design of the screen 40 or the associated display device 4 altogether also can be realized independent of the concrete size and arrangement of the display device 4 or the screen 40 with respect to the outlet opening 3.

The subject-matter of the invention in particular also is a motor vehicle steering wheel with at least one gripping portion for gripping the steering wheel by a driver (in particular in the form of a steering wheel rim) and with a central steering wheel region which is connected with the gripping portion and which—based on the state of the steering wheel properly mounted in a motor vehicle—forms a cover surface facing the driver, wherein on the cover surface an electronic display device with a screen is arranged, and wherein the screen 40 of the electronic display device 4 and/or the display device 4 altogether can be removed from the central steering wheel region 2. For this purpose, the screen 40 and/or the electronic display device 4 altogether can be removably mounted on a holder 46 provided on the central steering wheel region 2.

According to a development of this subject-matter of the invention, a receptacle 35 for a gas bag 36 of an airbag module can be arranged behind the cover surface 20 of the central steering wheel region 2 and the cover surface 20 can define an outlet opening 3 through which the gas bag 36 can be deployed for the protection of a driver. In this case, the display device 4 with the screen 40 is arranged on the cover surface 20 of the central steering wheel region 2 beside the outlet opening 3.

With reference to the more detailed representation of FIG. 1 it furthermore becomes clear that on the central steering wheel region 2, more exactly in particular on its cover surface 20, in addition to the outlet opening 3 for a gas bag or the associated cover 30 as well as to the screen 40 further functional elements yet are arranged, in particular control elements 5a, 5b; 6a, 6b for example in the form of switches, pushbuttons or rotary knobs, and/or additional display elements 7, for example in the form of status lights.

The additional display elements 7 for example can be arranged adjacent to the screen 4. They in particular serve as status indicators, for example with a view to the status of the headlamps, with a view to the fuel level etc.

The control elements 5a, 5b; 6a, 6b or at least a part of the control elements advantageously is arranged such that they can be reached manually and hence can be actuated manually, while the driver grasps the gripping region 1a, 1b of the steering wheel by stretching a finger in direction of the corresponding control element. For this purpose, the control elements 5a, 5b; 6a, 6b in particular can be arranged laterally on both sides of the screen 40 and/or on both sides of the outlet opening 3 or the associated cover 30.

In particular the control elements 5a, 5b arranged in the surroundings of the screen 40 can be assignable with different functions in dependence on the information currently displayed on the screen, controlled by a control device associated to the display device 4. For example, when contents relating to the navigation system are displayed on the screen 40, the corresponding control elements 5a, 5b can be assigned with functions for operating the navigation system. On the other hand, when contents relating to mobile telephony are displayed on the screen 40, the corresponding control elements 5a, 5b can serve for operating a telephone etc. The respective function of the control elements 5a, 5b advantageously can be displayed on the respective control element or on the screen 40 beside the respective control element.

Due to such multiple assignment of individual control elements the total number of necessary control elements can be reduced considerably.

The variable assignment or multiple assignment of individual control elements with different functions also can be realized independent of the arrangement of a screen in the central steering wheel region of the steering wheel.

Subject-matter of the present invention furthermore generally is a motor vehicle steering wheel with at least one control element 5a, 5b; 6a, 6b for actuating a functional component of a motor vehicle, such as for example a headlamp, a direction indicator (“flasher”), an air-conditioning system, a navigation device, a mobile phone, etc., wherein a control device is associated to the control element, in order to be able to vary the function of the control element, so that the control element can be utilized at different times for actuating different functional components of the motor vehicle, for example at a first time for actuating a navigation device and at another, second time for actuating a mobile phone. This means that the assignment of a certain function to the control element, so that the (manual) action on the control element leads to an actuation of a particular functional component of the motor vehicle, can variably be adjusted and hence be changed by means of the associated control device. The corresponding control element hence is available in principle to actuate different functional components of the motor vehicle, wherein it can be determined by means of the associated control device to which of the different functional components the control element each is associated at a respective time.

Such variable assignment or multiple assignment of a control element 5a, 5b; 6a, 6b with different functions can be advantageous in particular when beside the at least one control element a display device 4 with screen 40 additionally is integrated into the steering wheel 1, for example when in a central steering wheel region 2, which is connected with a gripping portion 1a, 1b of the steering wheel, such display device 4 with screen 40 is arranged, in particular according to the features of the generic part of claim 1. In this case it can be provided, for example, that the assignment of a particular control element 5a, 5b; 6a, 6b on the steering wheel depends on what kind of information currently is displayed on the screen 40 of the display device 4. For example, when the screen 40 of the display device 4 just is used for outputting optical messages of a navigation device, one or more control elements can serve for actuating the functional component “navigation device”. On the other hand, when the display device 4 with the screen 40 just is used for outputting optical information of a mobile radio device, the one or more control elements instead can be assigned with functions which provide for actuating the functional component “mobile phone”.

A reference to the functional component, which at a certain time each is associated to a particular control element 5a, 5b of the steering wheel, on the one hand can be represented on the respective control element 5a, 5b itself, or alternatively, if the control elements 5a, 5b are arranged beside a screen 40 of a display device 4, in the region of the screen 40 adjacent to the respective control element. The latter variant is indicated for some of the control elements 5a, 5b by way of example with reference numeral 52 on the screen 40 of the display device 4 as shown in FIG. 1.

In the case of an integration of control and display elements 5a, 5b; 6a, 6b; 7 into the steering wheel and in particular into the central steering wheel region 2, the dashboard (instrument panel) otherwise used therefore as well as the center console can be relieved of such elements and for example primarily be created under design aspects.

In particular, it is also possible to integrate all control and/or display elements, which must be reachable by a driver in operation of the motor vehicle, into the steering wheel.

1. A motor vehicle steering wheel, comprising
at least one gripping portion for gripping the steering wheel by a driver, and
a central steering wheel region which is connected with the gripping portion and which—based on the state of the steering wheel properly mounted in a motor vehicle—forms a cover surface facing the driver,
wherein behind the cover surface a receptacle for a gas bag is arranged and the cover surface defines an outlet opening through which the gas bag can be deployed for the protection of the driver, and wherein the steering wheel furthermore comprises an electronic display device with a screen,
wherein the screen is provided beside the outlet opening on the cover surface of the central steering wheel region and that the surface of the screen amounts to at least 60% of the opening cross-section of the outlet opening, and
wherein the screen is touch-sensitive, so that by action on the screen commands to components of the motor vehicle can be generated.

2. The motor vehicle steering wheel according to claim 1, wherein the surface of the screen amounts to at least 80% of the opening cross-section of the outlet opening.

3. The motor vehicle steering wheel according to claim 1, wherein the surface of the screen is at least as large as the opening cross-section of the outlet opening.

4. The motor vehicle steering wheel according to claim 1, wherein the outlet opening and the screen substantially lie in a plane which extends vertically to the steering axis.

5. The motor vehicle steering wheel according to claim 1, wherein the outlet opening is closed by means of a cover which covers the gas bag arranged in the receptacle.

6. The motor vehicle steering wheel according to claim 1, wherein in the deployed state the gas bag covers the screen.

7. The motor vehicle steering wheel according to claim 1, wherein the screen is removably arranged on a holder of the central steering wheel region.

8. The motor vehicle steering wheel according to claim 1, wherein the spatial orientation of the screen is adjustable.

9. The motor vehicle steering wheel according to claim 8, wherein the screen is pivotally arranged on the central steering wheel region.

10. The motor vehicle steering wheel according to claim 1, wherein the screen is divided into at least two regions, of which the one region serves for displaying information to be provided permanently in operation of a motor vehicle and the other region serves for displaying information required only at times during the operation of a motor vehicle.

11. The motor vehicle steering wheel according to claim 1, wherein the screen is actuated such that at least a part of the elements displayed on the screen maintains its spatial orientation independent of the steering angle of the steering wheel.

12. (canceled)

13. The motor vehicle steering wheel according to claim 1, wherein in the central steering wheel region further display elements are arranged in addition to the screen.

14. The motor vehicle steering wheel according to claim 13, wherein at least a part of the further display elements is arranged adjacent to the screen.

15. The motor vehicle steering wheel according to claim 1, wherein on the central steering wheel region control elements are arranged, with which functional components of the motor vehicle can be actuated.

16. The motor vehicle steering wheel according to claim 15, wherein at least a part of the control elements is arranged adjacent to the screen.

17. The motor vehicle steering wheel according to claim 15, wherein at least a part of the control elements can be assigned with different operating functions, in dependence on the content of information currently displayed on the screen.

18. The motor vehicle steering wheel according to claim 15, wherein at least a part of the control elements is reachable for a driver from the gripping region.

19. The motor vehicle steering wheel according to claim 1, wherein all control elements and/or all display elements, which during operation of a motor vehicle must be available for actuation by the driver, are arranged on the motor vehicle steering wheel.

20. The motor vehicle steering wheel according to claim 1, wherein the screen—based on the position of the steering wheel corresponding to a straight-ahead travel—is arranged in the 12 o'clock position relative to the outlet opening.
